(19) United States
(12) Patent Application Publication
(10) Pub. No.: US 2019/0119154 A1
(43) Pub. Date: Apr. 25, 2019

(54) GLASS SUBSTRATE WITH REDUCED INTERNAL REFLECTANCE AND METHOD FOR MANUFACTURING THE SAME

(71) Applicants: AGC GLASS EUROPE, Louvain-La-Neuve (BE); AGC GLASS COMPANY NORTH AMERICA, Alpharetta, GA (US); ASAHI GLASS CO LTD, Tokyo (JP); QUERTECH INGÉNIERIE, Caen (FR)

(72) Inventors: Benjamine NAVET, Louvain-La-Neuve (BE); Pierre BOULANGER, Couthuin (BE)

(73) Assignees: AGC GLASS EUROPE, Louvain-La-Neuve (BE); AGC GLASS COMPANY NORTH AMERICA, Alpharetta, GA (US); ASAHI GLASS CO LTD, Tokyo (JP); QUERTECH INGÉNIERIE, Caen (FR)

(21) Appl. No.: 16/092,533

(22) PCT Filed: Mar. 13, 2017
(86) PCT No.: PCT/EP2017/055847

§ 371 Date: Oct. 10, 2018

(30) Foreign Application Priority Data
Apr. 12, 2016 (EP) 16164911.6

(51) Int. Cl. C03C 23/00; C03C 3/097; C03C 3/091; C03C 3/087

(52) U.S. Cl. CPC C03C 23/0055; C03C 3/087; C03C 3/091; C03C 3/097

(57) ABSTRACT

The invention concerns a method for manufacturing glass substrates with reduced internal reflectance by ion implantation, comprising ionizing a source gas of N₂, O₂, Ar, and/or He so as to form a mixture of single charge and multicharge ions of N, O, Ar, and/or He forming a beam of single charge and multicharge ions of N, O, Ar, and/or He, by accelerating with an acceleration voltage comprised between 15 kV and 60 kV and an ion dosage comprised between 10¹⁷ ions/cm² and 10¹⁸ ions/cm². The invention further concerns glass substrates having reduced internal reflectance, comprising an area treated by ion implantation with a mixture of simple charge and multicharge ions according to this method.

The present invention relates to a glass substrate having a reduced internal reflectance for glazings and in particular for electro-optical devices and a method of manufacturing the same. More particularly the present invention relates to a glass substrate having a double porous surface layer to be used in particular as glass cover in electro-optical devices wherein multiple internal reflections in the cover glass leads to reduced performance. Such electro-optical devices comprise light emitting devices such as lights or displays as well as light collecting devices such as photovoltaic devices.

Organic light-emitting diodes (OLEDs) are flat large-area light sources with a diffuse light emission that are typical electro-optical devices suffering from multiple internal reflections in glass. A typical OLED structure consists of several organic layers sandwiched between two electrodes. It has been found that a large amount of the light OLEDs produce cannot be used because of a low level of light extraction or outcoupling efficiency. In fact the large difference on refractive index between air (n=1.0), glass (n=1.5), and organic layers (n=1.7 to 2.0), only a small fraction of light can leave the device. In a typical OLED only about 20% of the light is directly emitted into air and roughly the same amount is trapped inside the glass substrate owing to total internal reflection at the interface between glass and air. The rest is trapped by multiple internal reflections, an effect also known as waveguiding, inside the other OLED layers.

Anti-reflection coatings have been used to reduce reflectance at the glass/air interface. Such coatings however are in general strongly wavelength and angularly dependent and are therefore not always appropriate.

One way to improve outcoupling efficiency is to use an aerogel layer between the OLED layers and glass, in close proximity to the emitting layer. Aerogels have a very low refractive index between about 1.01 and 1.2. However, the silica aerogel has many drawbacks. It is brittle and its manufacturing process is complicated, requiring many process steps, and difficult to integrate in a OLED manufacturing process, making it an expensive solution. Furthermore it is very difficult to manufacture such aerogel layers on large substrates, i.e. substrates that have a surface of more than 1 m².

Another way to improve outcoupling is described in US 2013/0299792 A1. Here a glass substrate for OLEDs is treated with hexafluorosilicic acid (H₂SiF₆) which is saturated by the addition of SiO₂, and to which a boric acid solution may be added. In this wet chemical etching process at least one component of the glass substrate is eluted and a porous layer having a porous silica structure is formed in the glass substrate such that it extends inward from the surface of the glass substrate. However such wet chemical processes are dangerous, not only because of the acidity of the etchant, but also because of the toxicity of hydrogen fluoride that may be released when evaporated. Furthermore, in addition to the many process steps required, additional measures have to be taken to avoid contact of the etchant with the opposite substrate surface.

There is therefore a need in the art to provide glass substrates having a reduced internal reflection that can be produced with few process steps, on large scale substrates, and without toxic chemicals.

According to one of its aspects, the subject of the present invention is a method for producing a glass substrate having a double porous surface layer.

According to another aspect, the subject of the present invention is a glass substrate having a double porous surface layer.

According to another aspect, the subject of the present invention is the use of a glass substrate having a double porous surface layer for increasing the transmittance of a glazing, display or lighting device.

According to another aspect, the subject of the present invention is an electro-optical device comprising a glass substrate having reduced internal reflectance of the present invention.

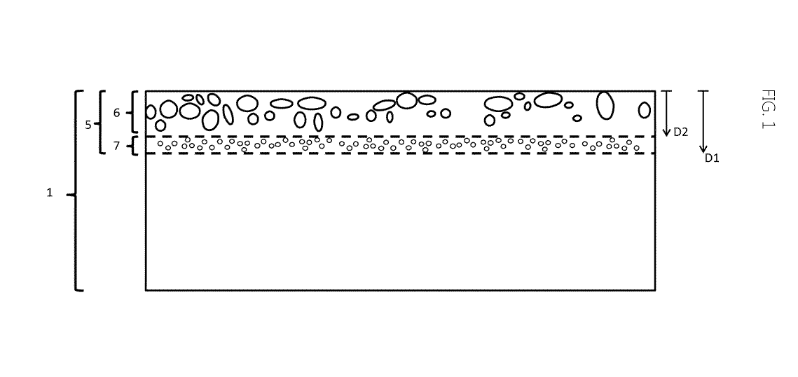

FIG. 1 shows a cross-section of a glass substrate having a double porous surface layer according to the present invention. (not to scale)

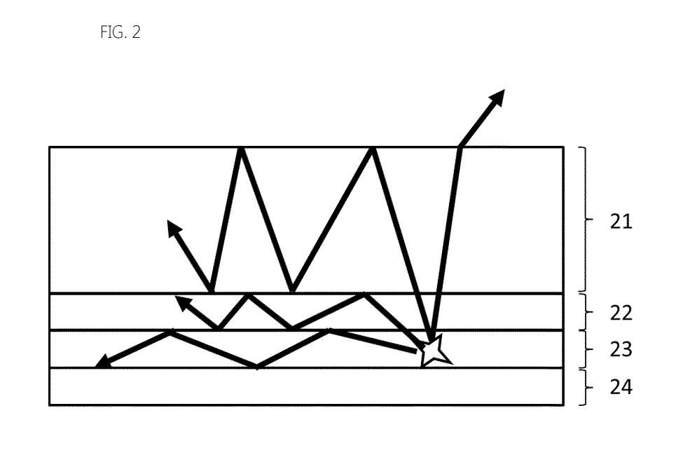

FIG. 2 is a cross-sectional and conceptual view depicting the light extraction efficiency of an OLED of the related art. (not to scale)

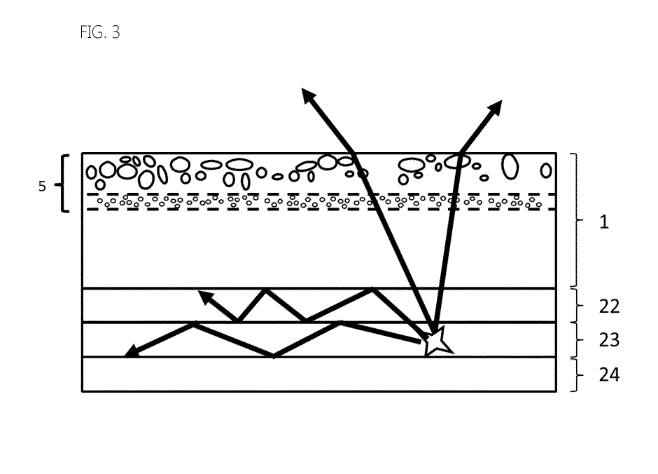

FIG. 3 is a cross-sectional and conceptual view depicting the light extraction efficiency of an OLED comprising a glass substrate of the present invention. (not to scale)

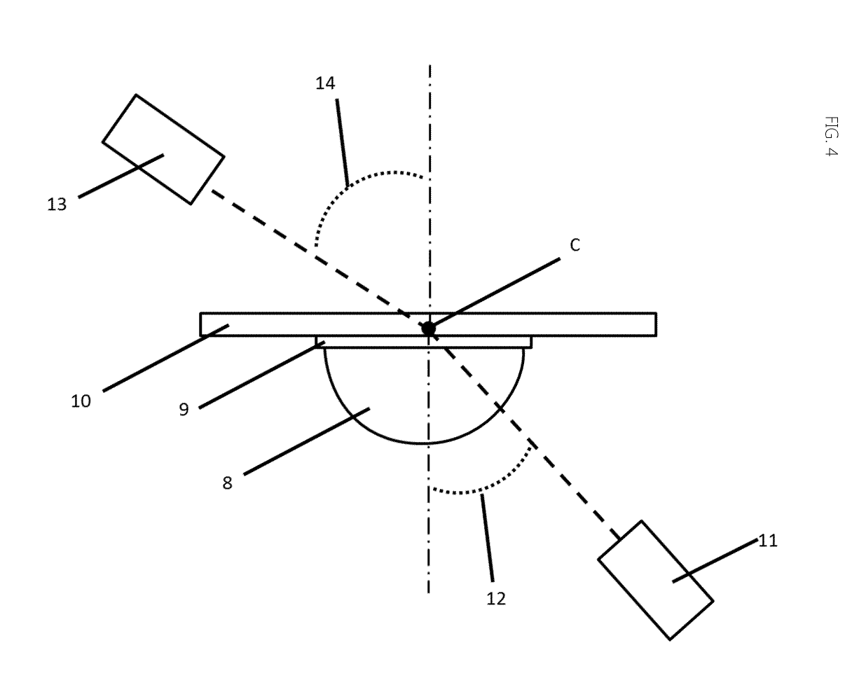

FIG. 4 schematically represents the device used to evaluate the influence of the double porous double layer of the present invention on the reduction of internal reflection. (not to scale)

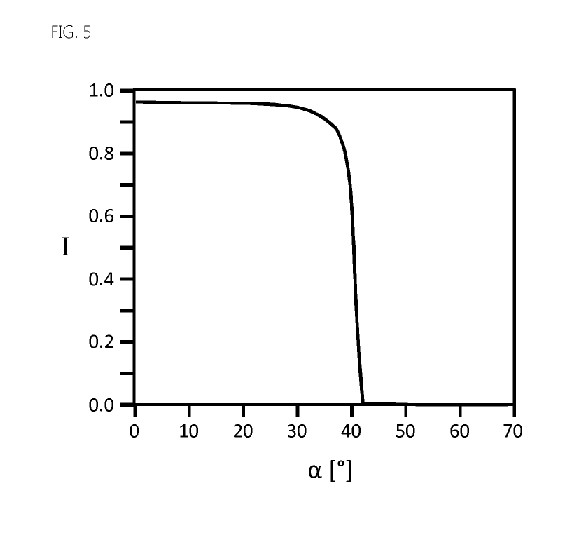

FIG. 5 shows a graph showing total transmitted light I versus the incoming light angle α for a common glass substrate.

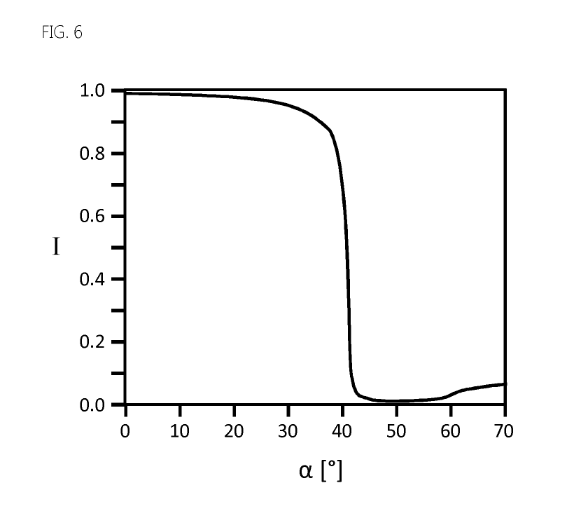

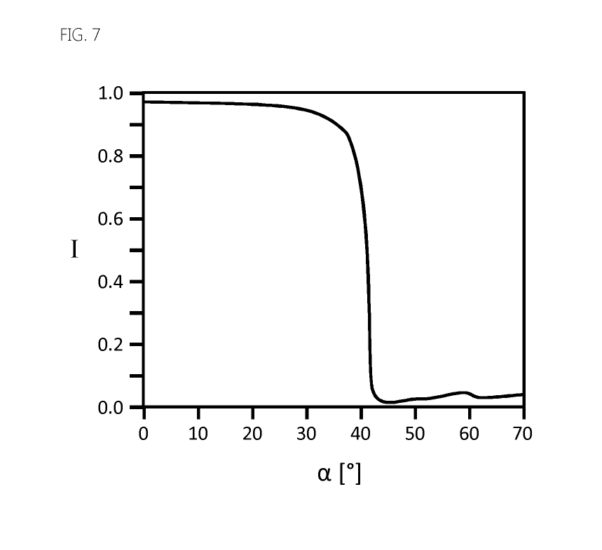

FIGS. 6-7 show graphs showing total transmitted light I versus the incoming light angle α for three different substrates according to the present invention.

The invention relates to a method for producing a glass substrate having a double porous surface layer comprising the following operations
providing a source gas selected among O₂, Ar, N₂ and/or He,
ionizing the source gas so as to form a mixture of single charge ions and multicharge ions O, Ar, N, and/or He,
accelerating the mixture of single charge ions and multicharge ions with an acceleration voltage so as to form a beam comprising a mixture of single charge ions and multicharge ions, wherein the acceleration voltage is comprised between 15 and 60 kV and the ion dosage is comprised between 10¹⁷ ions/cm² and 10¹⁸ ions/cm²,
providing a glass substrate,
positioning the glass substrate in the trajectory of the beam comprising a mixture of single charge and multicharge ions.

The inventors have surprisingly found, that the method of the present invention providing an ion beam comprising a mixture of single charge and multicharge ions of N, O, Ar, and/or He, accelerated with the same specific acceleration voltage and at such specific dosage, applied to a glass substrate, leads to a glass substrate having a double porous surface layer. As illustrated in FIG. 1, the resulting glass substrate (1) has a double porous surface layer (5) comprising an upper porous surface layer (6) with a first porosity and contiguously a lower porous surface layer (5) with a second porosity, which is different from the first porosity. The upper porous surface layer starts at the substrate surface and descends down to a depth D2, the lower porous surface layer starts at a depth D2 and descends down to a depth D1. The upper porous surface layer and the contiguous lower porous surface layer form the double porous surface layer.

Such glass substrates, having a double porous surface layer, by virtue of at least this specific combination of upper and lower porous layers have the advantage of providing a reduced internal reflectance, in particular at high incoming light angles, and are obtained through a process that is simple, environmentally friendly and upscaleable to large substrate sizes of at least 1 m².

As can be seen on the cross-sectional conceptual illustration of a typical OLED device of FIG. 2, the diffuse light generated in the light emitting layers (23) is largely trapped within the emitting layer (23) itself, the transparent cathode layer (22) and the glass substrate (21) by multiple reflections at the layer interfaces, also at the interface with the metallic anode (24).

As can be seen on the cross-sectional conceptual illustration of an OLED device comprising an glass substrate of the present invention in FIG. 3, the diffuse light generated in the light emitting layers (23) is trapped by multiple reflections within the emitting layer (23) itself and the transparent cathode layer (22). However, by virtue of the double porous surface layer of the present invention, the amount of light trapping is reduced at the glass air interface.

Advantageously the first porosity is characterized by the presence of pores whose size is at least double the average size of the pores of the second porosity. The method for determining the porosities, in particular the number and size of the pores is described below.

The ion source gas chosen among O₂, Ar, N₂ and/or He is ionized so as to form a mixture of single charge ions and multi charge ions of O, Ar, N, and/or He respectively. The mixture of single charge ions and multicharge ions is accelerated with an acceleration voltage so as to form a beam comprising a mixture of single charge ions and multicharge ions. This beam may comprise various amounts of the different O, Ar, N, and/or He ions. Example currents of the respective ions are shown in Table 1 below (measured in milli Ampere).

TABLE 1

| Ions | | Ions | | | Ions | | Ions | |
|---|---|---|---|---|---|---|---|---|
| of O | | of Ar | | | of N | | of He | |
| O+ | 1.35 mA | Ar+ | 2 | mA | N+ | 0.55 mA | He+ | 1.35 mA |
| O2+ | 0.15 mA | Ar2+ | 1.29 | mA | N2+ | 0.60 mA | He2+ | 0.15 mA |
| | | Ar3+ | 0.6 | mA | N3+ | 0.24 mA | | |
| | | Ar4+ | 0.22 | mA | | | | |
| | | Ar5+ | 0.11 | mA | | | | |

Porosity of a glass substrate's double porous surface layer is controlled, for a given glass type, by choosing the appropriate ion implantation treatment parameters. For a given ion source gas, the key ion implantation parameters are the ion acceleration voltage and the ion dosage.

While not wishing to be bound by any theory, it appears that by the method of the present invention concentrations of ions sufficient for the formation of pores in the glass substrate are obtained. In the first porous layer the concentration of ions is such that larger pores are formed than in the second porous layer. Seemingly this results from different amounts of single charge and multicharge ions being implanted up to different depth due to their charge dependent implantation energy.

The positioning of the glass substrate in the trajectory of the beam of single charge and multicharge ions is chosen such that certain amount of ions per surface area or ion dosage is obtained. The ion dosage, or dosage is expressed as number of ions per square centimeter. For the purpose of the present invention the ion dosage is the total dosage of single charge ions and multicharge ions. The ion beam preferably provides a continuous stream of single and multicharge ions. The ion dosage is controlled by controlling the exposure time of the substrate to the ion beam. According to the present invention multicharge ions are ions carrying more than one positive charge. Single charge ions are ions carrying a single positive charge.

In one embodiment of the invention the positioning comprises moving glass substrate and ion implantation beam relative to each other so as to progressively treat a certain surface area of the glass substrate. Preferably they are moved relative to each other at a speed comprised between 0.1 mm/s and 1000 mm/s. The speed of the movement of the glass relative to the ion implantation beam is chosen in an appropriate way to control the residence time of the sample in the beam which influences ion dosage of the area being treated.

The method of the present invention can be easily scaled up so as to treat large substrates of more than 1 m², for example by continuously scanning the substrate surface with an ion beam of the present invention or for example by forming an array of multiple ion sources that treat a moving substrate over its whole width in a single pass or in multiple passes.

According to the present invention the acceleration voltage and ion dosage are preferably comprised in the following ranges:

TABLE 2

| parameter | general range | preferred range | most preferred range |
|---|---|---|---|
| Acceleration | 15 to 60 | 20 to 40 | 30 to 40 |
| voltage [kV] | | | |
| Ion dosage | 10¹⁷ to 10¹⁸ | 2.5 × 10¹⁷ to 7.5 × | 2.5 × 10¹⁷ to 5 × |
| [ions/cm²] | | 10¹⁷ | 10¹⁷ |

The inventors have found that ion sources providing an ion beam comprising a mixture of single charge and multicharge ions, accelerated with the same acceleration voltage are particularly useful as they may provide lower dosages of multicharge ions than of single charge ions. It appears that a glass substrate having a double porous surface layer may be obtained with the mixture of single charge ions, having higher dosage and lower implantation energy, and multicharge ions, having lower dosage and higher implantation energy, provided in such a beam. The implantation energy, expressed in Electron Volt (eV) is calculated by multiplying the charge of the single charge ion or multicharge ion with the acceleration voltage.

In a preferred embodiment of the present invention the temperature of the area of the glass substrate being treated, situated under the area being treated is less than or equal to the glass transition temperature of the glass substrate. This temperature is for example influenced by the ion current of the beam, by the residence time of the treated area in the beam and by any cooling means of the substrate.

In a preferred embodiment of the invention only one type of implanted ions is used, the type of ion being selected among ions of N, O, or Ar. In another embodiment of the invention two or more types of implanted ions are combined, the types of ion being selected among ions of N, O, or Ar. These alternatives are covered herein by the wording “and/or”.

In one embodiment of the invention several ion implantation beams are used simultaneously or consecutively to treat the glass substrate.

In one embodiment of the invention the total dosage of ions per surface unit of an area of the glass substrate is obtained by a single treatment by an ion implantation beam.

In another embodiment of the invention the total dosage of ions per surface unit of an area of the glass substrate is obtained by several consecutive treatments by one or more ion implantation beams.

The method of the present invention is preferably performed in a vacuum chamber at a pressure comprised between 10² mbar and 10⁷ mbar, more preferably at between 10⁵ mbar and 10⁶ mbar.

An example ion source for carrying out the method of the present invention is the Hardion+ RCE ion source from Quertech Ingénierie S.A.

The glass substrate according to this invention may be a glass sheet of any thickness having the following composition ranges expressed as weight percentage of the total weight of the glass:

| | |
|---|---|
| SiO₂ | 35-85%, |
| Al₂O₃ | 0-30%, |
| P₂O₅ | 0-20% |
| B₂O₃ | 0-20%, |
| Na₂O | 0-25%, |
| CaO | 0-20%, |
| MgO | 0-20%, |
| K₂O | 0-20%, and |
| BaO | 0-20%. |

The glass substrate according to this invention is preferably a glass sheet chosen among a soda-lime glass sheet, a borosilicate glass sheet, or an aluminosilicate glass sheet.

The glass substrates of the present invention are particularly useful in combination with electro-optical devices such as light-emitting devices and photovoltaic device. In particular, they may be used as substrates for OLED devices or as cover glasses or substrates for photovoltaic devices. They may for example be used laminated directly to an electro-optical device or laminated to another glass substrate, with an electro-optical device integrated in between the two laminated glass substrates. The glass substrate of the present invention may also be tempered. The double porous surface layer is preferably the at the glass-air interface. When used as a substrate for an electro-optical device, the porous double surface layer may also be in contact the electro-optical device.

The present invention also concerns the use of a mixture of single charge and multicharge ions to form a double porous surface layer in a glass substrate the mixture of single charge and multicharge ions being implanted in the glass substrate with a dosage and acceleration voltage effective to form a double porous surface layer in the glass substrate.

The inventors found that using a mixture of single charge and multicharge ions for the implantation in to a glass substrate with an appropriate acceleration voltage and ion dosage leads to the formation of a double porous surface layer in a glass substrate.

Ultimately this double porous surface layer leads to a reduced internal reflectance of the glass substrate.

According to a preferred embodiment the resulting glass substrate has a double porous surface layer comprising an upper porous surface layer with a first porosity and contiguously a lower porous surface layer with a second porosity, which is different from the first porosity. The upper porous surface layer starts at the substrate surface and descends down to a depth D2, the lower porous surface layer starts at a depth D2 and descends down to a depth D1. The upper porous surface layer and the contiguous lower porous surface layer form the double porous surface layer. The depth D1 is equivalent to the thickness of the double porous surface layer. Preferably the depth D2 is comprised between 100 and 300 nm and the depth D1 is comprised between 150 and 450 nm.

According to an embodiment of the present invention the upper porous layer comprises pores having a cross-sectional equivalent circular diameter comprised between 21 and 200 nm and the lower porous layer comprises only pores that a cross-section equivalent circular diameter comprised between 3 nm and 10 nm or less. The cross-sectional equivalent circular diameter is determined on a TEM image of a cross section of the double porous surface layer as explained below. The lower limit of the cross-sectional equivalent circular diameter is set at 3 nm for the pores of the lower porous layer as this is the lowest diameter that can be reliably determined by this method.

According to an embodiment of the present invention the 10 to 40% of the cross-sectional area of the upper porous layer is occupied by pores having a cross-sectional equivalent circular diameter comprised between 21 and 200 nm.

It was furthermore found that the pores of the upper porous sublayer are predominantly closed pores, preferably comprising less than 10% of open pores. Closed pores are for example less sensitive to soiling than open pores.

Such glass substrates, having a double porous surface layer, by virtue of at least this specific combination of upper and lower porous layers have the advantage of providing substrates that have a reduced internal reflectance, in particular at high incoming light angles, and are obtained through a process that is simple, environmentally friendly and upscaleable to large substrate sizes of at least 1 m². Preferably the reflectance is reduced for incoming light angles, relative to the normal of the substrate surface, comprised between 50° and 70°, more preferably comprised between 50° and 60°.

The ion types that may be implanted into these substrate are ions of O, Ar, N, and/or He respectively. The ions may be single charge ions, multicharge ions or a mixture of single charge and multicharge ions. Multicharge ions are ions carrying more than one positive charge. Single charge ions are ions carrying a single positive charge. Single charge ions implanted in the glass substrate may be the single charge ions O⁺, Ar⁺, N⁺ and/or He⁺. Multicharge ions implanted in the glass substrate are for example O²⁺ or Ar²⁺, Ar³⁺, Ar⁴⁺ and Ar⁺ or N²⁺ and N³⁺ or He²⁺.

Preferably the mixtures of multicharge and single charge ions of O, Ar, N and/or He comprise respectively lower amounts of the most O²⁺ than O⁺, lower amounts of Ar^{2′}, Ar³⁺, Ar⁴⁺ and Ar⁵⁺ than Ar⁺, lower amounts of N²⁺ and N³⁺ than of N⁺, lower amounts of He²⁺ than of He⁺.

In these porous glass substrates the implantation depth of the ions may be comprised between 0.1 μm and 1 μm, preferably between 0.1 μm and 0.5 μm.

Such an ion source is for example the Hardion+ RCE ion source from Quertech Ingénierie S.A.

The porosities of the porous glass substrate are determined by image processing of Transmission Electron Microscope (TEM) images cross section of the treated glass substrate. By image processing number of bubbles.

The microstructure of the treated glass substrates, in particular pore size and distribution were investigated by Transmission Electron Microscope (TEM). Cross-sectional specimens were prepared via focused ion beam (FIB). During preparation, process carbon and Pt protective layers were deposited on top of the glass. The bright field transmission electron microscopy (BF TEM), high angle annular dark field scanning transmission electron microscopy (HAADF-TEM) were performed on a FEI Tecnai Osiris and on a FEI Tecnai G2 electron microscopes operated at 200 kV. For the purpose of the present invention the pore two-dimensional pore sizes as determined by the present method are considered to be representative of the three-dimensional size of the pores.

The porosities were evaluated from the TEM micrographs as schematically shown in FIG. 1. The images were processed with image analysis software ImageJ (developed by the National Institutes of Health, USA) to identify the pores as well-defined bright areas. Based on the analysis of a cross-section, for example of 4250 nm width, the depth D1 of the porous area, that is the depth up to which pores are observed, was determined. In the samples according to the present invention two very distinct areas, an upper area and a lower area, were observed. The upper area, starting at the substrate surface and reaching down to depth D2 comprises pores having an equivalent circular diameter of 21-200 nm. The upper area corresponds to the cross-section of the upper porous surface layer. The lower area, starting at the depth D2 and reaching down to the depth D1, comprises only pores having an equivalent circular diameter of about 3 nm to 10 nm. The lower area corresponds to the cross-section of the lower porous surface layer. The upper porous surface layer and the contiguous lower porous layer form the double porous surface layer. The cross-sectional equivalent circular diameter of a pore, usually having an irregular shape, is the diameter of a two-dimensional disk having an equivalent area to the cross-section of the pore as determined by this image analysis method. Pores having an equivalent circular diameter of 20 nm or less may also be present in the upper area.

FIG. 4 shows a schematic representation of the device used to evaluate the influence of the double porous layer of the present invention on the reduction of internal reflection. A half-sphere (8) having the same refractive index as the glass substrate (10) is contacting the glass substrate via an index matching liquid layer (9). The glass substrate (10) and the index matching liquid layer (9) are thin compared with the half-sphere (8) for input coupling, thus the incidence of the light beam onto the half-sphere is always normal. The beam of a laser (11) of 550 nm wavelength is aimed through the round surface of the half sphere at point C situated in the middle of the substrate below the center of the flat surface of the half sphere. The laser is rotated in a two dimensional plane so as to cover different incoming angles α (12). The incoming angle α is varied from 0°, normal to the substrate surface, to 70°. For each incoming angle, a detector (13) positioned on the side of the substrate opposite to the laser is rotated in the same two dimensional plane so as to cover different output angles (14). For each incoming angle setting the detector measures the power of the transmitted light over an output angle range going from +85° to −85°, where the 0° angle is normal to the substrate surface. For each incoming angle setting the total transmitted light intensity I is calculated. The lower the amount of internal reflection at an angle α, the higher the total transmitted light intensity I at this angle α. The result is plotted in a graph showing total transmitted light I (arbitrary units) versus the incoming light angle α (in degrees).

### DETAILED DESCRIPTION OF PARTICULAR EMBODIMENTS

The ion implantation examples were prepared according to the various parameters detailed in the tables below using an RCE ion source for generating a beam of single charge and multicharge ions. The ion source used was a Hardion+ RCE ion source from Quertech Ingénierie S.A.

All samples had a size of 10×10 cm² and were treated on the entire surface by displacing the glass substrate through the ion beam at a speed between 20 and 30 mm/s.

The temperature of the area of the glass substrate being treated was kept at a temperature less than or equal to the glass transition temperature of the glass substrate.

For all examples the implantation was performed in a vacuum chamber at a pressure of 10⁻⁶ mbar.

Using the RCE ion source, ions of N were implanted in 4 mm thick regular clear soda-lime glass substrates. Before being implanted with the ion implantation method of the present invention the reflectance of the glass substrates was about 8%. The key implantation parameters can be found in the table below.

TABLE 4

| | | | acceleration | ion dosage |
|---|---|---|---|---|
| reference | Source gas | glass substrate | voltage [kV] | [ions/cm²] |
| E1 | N2 | Sodalime | 35 | 2.5 × 10¹⁷ |
| E2 | N2 | Sodalime | 35 | 7.5 × 10¹⁷ |
| C1 | — | Sodalime | — | — |

The key pore measurements can be found in the table below. Counterexample C1, a sodalime glass substrate that has not been submitted to ion implantation treatment does not present any pores.

TABLE 5

| reference | E1 | E2 |
|---|---|---|
| D2 [nm] | 90 | 135 |
| D1 [nm] | 180 | 225 |
| Surface pore density of upper porous are [pores per μm²] | 89 | 133 |
| Average upper porous area pore equivalent diameter [nm] | 52 | 53 |
| Maximum upper porous area pore equivalent diameter [nm] | 95 | 156 |
| Minimum upper porous area pore equivalent diameter [nm] | 21 | 21 |
| Maximum lower porous area pore equivalent diameter [nm] | 10 | 10 |
| Minimum upper porous area pore equivalent diameter [nm] | 3 | 3 |

As can be seen from the table 5 above, Examples E1 and E2 of the present invention, treatment of the sodalime glass samples with an ion beam comprising a mixture of single charge and multicharge ions of N, accelerated with the same specific acceleration voltage and at such specific dosage, applied to a glass substrate, leads to the formation of a double porous surface layer in the glass substrate.

FIG. 5 shows a graph showing total transmitted light I versus the incoming light angle α for the common glass substrate of comparison example C1.

FIG. 6 shows a graph showing total transmitted light I versus the incoming light angle α for example E2 according to the present invention.

FIG. 7 shows a graph showing total transmitted light I versus the incoming light angle α for example E1 according to the present invention.

As can be seen on FIG. 5, the common glass substrate C1 shows total internal reflection starting at an incoming light angle of about 42° as the intensity of transmitted light falls to 0 (arbitrary units). On FIGS. 6 and 7, examples E1 and E2 show a similar drop in transmitted light towards an incoming light angle of about 42° as C1. However E1 and E2 show a small but significant level of light intensity for incoming light angles up to at least 70°. Thus the glass substrates of the present invention, in combination with an lighting device increase the outcoupling efficiency.

1: A method for producing a glass substrate with reduced internal reflectance, the method comprising:
a) ionizing at least one source gas selected from the group consisting of N₂, O₂, Ar, and He, so as to form a mixture of single charge ions and multicharge ions of N, O, Ar, and/or He,
b) accelerating the mixture of single charge ions and multicharge ions with an acceleration voltage so as to form a beam of single charge ions and multicharge ions, wherein the acceleration voltage is 15 kV to 60 kV and the ion dosage is 10¹⁷ ions/cm² to 10¹⁸ ions/cm², and
c) positioning a glass substrate in the trajectory of the beam of single charge and multicharge ions.

2: The method according to claim 1, wherein the acceleration voltage is 20 kV to 40 kV and the ion dosage is 2.5×10¹⁷ ions/cm² to 7.5×10¹⁷ ions/cm².

3: The method according to claim 2, wherein the acceleration voltage is 30 kV to 40 kV and the ion dosage is 2.5×10¹⁷ ions/cm² to 5×10¹⁷ ions/cm².

4: The method according to claim 1, wherein the glass substrate in c) comprises the following components, expressed as weight percentage of a total weight of the glass:

| | |
|---|---|
| SiO₂ | 35-85%, |
| Al₂O₃ | 0-30%, |
| P₂O₅ | 0-20% |
| B₂O₃ | 0-20%, |
| Na₂O | 0-25%, |
| CaO | 0-20%, |
| MgO | 0-20%, |
| K₂O | 0-20%, and |
| BaO | 0-20%. |

5: The method according to claim 4 wherein the glass substrate is selected from the group consisting of a soda-lime glass sheet, a borosilicate glass sheet and an aluminosilicate glass sheet.

6: The method according to claim 1, which produces a double porous surface layer in the glass substrate, the mixture of single charge and multicharge ions being implanted in the glass substrate with a dosage and acceleration voltage effective to form the double porous surface layer in the glass substrate.

7: The method according to claim 6, wherein the mixture of single charge and multicharge ions is being implanted in the glass substrate with a dosage and acceleration voltage effective to form a double porous surface layer comprising an upper porous surface layer with a first porosity and contiguously a lower porous surface layer with a second porosity,
a) wherein the upper porous surface layer starts at the substrate surface and descends down to a depth D2, and
b) wherein the lower porous surface layer starts at a depth D2 and descends down to a depth D1.

8: The method according to claim 6, wherein the mixture of single charge and multicharge ions is implanted in the glass substrate with a dosage and acceleration voltage effective to form a double porous surface layer,
a) wherein the upper porous layer comprises pores having a cross-sectional equivalent circular diameter of 21 nm to 200 nm, and
b) wherein the lower porous layer comprises only pores having a cross-section equivalent circular diameter of 3 nm to 10 nm.

9: A glass substrate with reduced internal reflectance produced by the method according to claim 1.

10: An electro-optical device comprising the glass substrate according to claim 9.

11: The electro-optical device according to claim 10, wherein the electro-optical device is an OLED device or a photovoltaic device.

12: The method according to claim 8, wherein the mixture of single charge and multicharge ions is implanted in the glass substrate with a dosage and acceleration voltage effective to form a double porous surface layer and wherein 10 to 40% of the cross-sectional area of the upper porous layer is occupied by pores having a cross-sectional equivalent circular diameter of 21 nm to 200 nm.
